(19) United States
(12) Patent Application Publication
(10) Pub. No.: US 2026/0113097 A1
(43) Pub. Date: Apr. 23, 2026

(54) METHOD AND APPARATUS FOR DETERMINING PRECODING MATRIX FOR UPLINK MIMO TRANSMISSION

(71) Applicant: Beijing Xiaomi Mobile Software Co., Ltd., Beijing (CN)

(72) Inventors: Zhenyu ZHANG, Beijing (CN); Xueyuan GAO, Beijing (CN)

(73) Assignee: Beijing Xiaomi Mobile Software Co., Ltd., Beijing (CN)

(21) Appl. No.: 18/998,938

(22) PCT Filed: Aug. 4, 2022
(86) PCT No.: PCT/CN2022/110384

§ 371 Date: Jan. 27, 2025

(51) Int. Cl. H04B 7/06; H04L 27/26

(52) U.S. Cl. CPC H04B 7/0639; H04B 7/06952; H04L 27/261

(57) ABSTRACT

A method for determining a precoding matrix for uplink MIMO transmission includes sending an SRS of eight antenna ports to a network device; receiving indication information sent by the network device, where the indication information is used for determining a target precoding matrix required for uplink transmission; and precoding data according to the target precoding matrix, and sending the precoded data to the network device.

### CROSS-REFERENCE TO RELATED APPLICATION

The present application is a U.S. National Stage of International Application No. PCT/CN2022/110384, filed on Aug. 4, 2022, the entire content of which is incorporated herein by reference for all purposes.

### TECHNICAL FIELD

The present application relates to the field of communication technology and, in particular, to a method and apparatus for determining a precoding matrix for uplink multiple input multiple output (MIMO)) transmission.

### BACKGROUND

Precoding techniques in MIMO systems can effectively reduce interference and system overhead, enhance system capacity, and are extremely important key techniques in the MIMO systems. Codebook design is also an important part of the precoding technique in the MIMO system based on codebook transmission. The maximum number of antenna ports supported by the codeword of the existing uplink MIMO transmission is four. With the enhancement of transmission requirements and transmission scenarios, uplink transmission may support an increased number of antenna ports and an increased number of uplink transmission layers, i.e., the number of antenna ports may be increased from four antenna ports to a maximum of eight antenna ports, and accordingly, the number of uplink transmission layers may be changed from four to L, e.g., the value of L may be ranged from one to eight.

### SUMMARY

Embodiments of the present application provide a method and apparatus for determining a precoding matrix for uplink MIMO transmission.

In a first aspect, the embodiments of the present application provide a method for determining a precoding matrix for uplink MIMO transmission. The method includes:
sending an SRS of eight antenna ports to a network device;
receiving indication information sent by the network device, where the indication information is used for determining a target precoding matrix required for uplink transmission; and
precoding data according to the target precoding matrix, and sending the precoded data to the network device.

In a second aspect, the embodiments of the present application provide a method for determining a precoding matrix for uplink MIMO transmission. The method includes:
receiving an SRS of eight antenna ports sent by a terminal device;
determining indication information based on the SRS, and sending the indication information to the terminal device, where the indication information is used for determining a target precoding matrix required for uplink transmission; and
receiving data sent by the terminal device after the terminal device performs precoding on the data according to the target precoding matrix.

In a third aspect, the embodiments of the present application provide a communication device. The communication device includes a processor. The processor, when invoking a computer program in the memory, performs the method according to the first aspect described above.

In a fourth aspect, the embodiments of the present application provide a communication device. The communication device includes a processor. The processor, when invoking a computer program in the memory, performs the method according to the second aspect described above.

In a fifth aspect, the embodiments of the present application provide a communication device. The communication device includes a processor and a memory. The memory stores a computer program. The processor executes the computer program stored in the memory to cause the communication device to perform the method according to the first aspect described above.

In a sixth aspect, the embodiments of the present application provide a communication device. The communication device includes a processor and a memory. The memory stores a computer program. The processor executes the computer program stored in the memory to cause the communication device to perform the method according to the second aspect described above.

In a seventh aspect, the embodiments of the present application provide a communication device. The device includes a processor and an interface circuit. The interface circuit is configured to receive a code instruction and transmit the code instruction to the processor. The processor is configured to run the code instruction to cause the device to perform the method according to the first aspect described above.

In an eighth aspect, the embodiments of the present application provide a communication device. The device includes a processor and an interface circuit. The interface circuit is configured to receive a code instruction and transmit the code instruction to the processor. The processor is configured to run the code instruction to cause the device to perform the method according to the second aspect described above.

In a ninth aspect, the embodiments of the present invention provide a computer-readable storage medium used for storing an instruction for use by the terminal device described above. When the instruction is executed, the terminal device is caused to perform the method according to the first aspect described above.

In a tenth aspect, the embodiments of the present invention provide a computer-readable storage medium used for storing an instruction for use by the network device described above. When the instruction is executed, the network device is caused to perform the method according to the second aspect described above.

In an eleventh aspect, the present application further provides a computer program product including a computer program that, when run on a computer, causes the computer to perform the method according to the first aspect described above.

In a twelfth aspect, the present application further provides a computer program product including a computer program that, when run on a computer, causes the computer to perform the method according to the second aspect described above.

In a thirteenth aspect, the present application provides a chip system. The chip system includes at least one processor and an interface, and is configured to support the terminal device in implementing the function involved in the first aspect, e.g., determining or processing at least one of the data and information involved in the method described above. In a possible design, the chip system further includes a memory. The memory is configured to store necessary computer programs and data of the terminal device. The chip system may be composed of a chip, or may include a chip and other discrete components.

In a fourteenth aspect, the present application provides a chip system. The chip system includes at least one processor and an interface, and is configured to support the network device in implementing the function involved in the second aspect, e.g., determining or processing at least one of the data and information involved in the method described above. In a possible design, the chip system further includes a memory. The memory is configured to store necessary computer programs and data of the network device. The chip system may be composed of a chip, or may include a chip and other discrete components.

In a fifteenth aspect, the present application provides a computer program that, when run on a computer, causes the computer to perform the method according to the first aspect described above.

In a sixteenth aspect, the present application provides a computer program that, when run on a computer, causes the computer to perform the method according to the second aspect described above.

### BRIEF DESCRIPTION OF THE DRAWINGS

In order to more clearly illustrate the technical solutions in the embodiments of the present application or the background art, the accompanying drawings to be used in the embodiments of the present application or the background art are described below.

FIG. 1 is a schematic diagram of an architecture of a communication system provided by an embodiment of the present application;

FIG. 2 is a flowchart of a method for determining a precoding matrix for uplink MIMO transmission provided by an embodiment of the present application;

FIG. 3 is a flowchart of another method for determining a precoding matrix for uplink MIMO transmission provided by an embodiment of the present application;

FIG. 4 is a flowchart of another method for determining a precoding matrix for uplink MIMO transmission provided by an embodiment of the present application;

FIG. 5 is a flowchart of another method for determining a precoding matrix for uplink MIMO transmission provided by an embodiment of the present application;

FIG. 6 is a flowchart of another method for determining a precoding matrix for uplink MIMO transmission provided by an embodiment of the present application;

FIG. 7 is a flowchart of another method for determining a precoding matrix for uplink MIMO transmission provided by an embodiment of the present application;

FIG. 8 is a flowchart of another method for determining a precoding matrix for uplink MIMO transmission provided by an embodiment of the present application;

FIG. 9 is a flowchart of another method for determining a precoding matrix for uplink MIMO transmission provided by an embodiment of the present application;

FIG. 10 is a schematic diagram of a structure of a communication apparatus provided by an embodiment of the present application;

FIG. 11 is a schematic diagram of a structure of a communication device provided by an embodiment of the present application;

FIG. 12 is a schematic diagram of a structure of a chip provided by an embodiment of the present application.

### DETAILED DESCRIPTION

Exemplary embodiments are described in detail here, examples of which are indicated in the accompanying drawings. When the following description involves the accompanying drawings, the same numerals in different accompanying drawings indicate the same or similar elements unless otherwise indicated. The embodiments described in the following exemplary embodiments do not represent all embodiments consistent with the present disclosure. On the contrary, they are only examples of devices and methods consistent with some aspects of the present disclosure as detailed in the appended claims.

The terms used in the embodiments of the present disclosure are used solely for the purpose of describing particular embodiments, and are not intended to limit the embodiments of the present disclosure. The singular forms of “a” and “the” used in the embodiments of the present disclosure and the appended claims are also intended to include the majority form, unless the context clearly indicates other meanings. It should also be understood that the term “and/or” as used in this article refers to and includes any or all possible combinations of one or more of the associated listed items.

It should be understood that although the terms first, second, and third, etc. may be used in the embodiments of the present disclosure to describe various types of information, such information should not be limited to these terms. These terms are only used for distinguishing the same type of information from one another. For example, without departing from the scope of the embodiments of the present disclosure, the first information may also be referred to as the second information, and similarly, the second information may also be referred to as the first information. Depending on the context, the phrase “if” as used herein may be interpreted as “at the time of . . . ”, “when . . . ”, or “in response to determining”. For the purpose of brevity and ease of understanding, the terms “greater than” or “less than”, and “higher than” or “lower than” are used in this article to characterize magnitude relationships. However, for those skilled in the art, it can be understood that the term “greater than” also covers the meaning of “greater than or equal to”, the term “less than” also covers the meaning of “less than or equal to”, the term “higher than” covers the meaning of “higher than or equal to”, and the term “lower than” covers the meaning of “lower than or equal to”.

For ease of understanding, the terms involved in the present application are first introduced.

A physical uplink shared channel (PUSCH) is used for carrying data from a transport channel PUSCH.

Coherent transmission is defined as a capability of a user equipment (UE), and the coherent transmission capability of the UE includes:
full Coherence transmission: all antenna ports can perform coherent transmission;
partial coherence transmission: antenna ports within the same coherent transmission group can perform coherent transmission, antenna ports within different coherent transmission groups cannot perform coherent transmission, and each coherent transmission group includes at least two antenna ports; and
non coherence transmission: no antenna port can perform coherent transmission.

With the increase in the number of antenna ports and the number of transmission layers, the number of codewords in the codebook will be caused to be increased significantly, bringing about more TPMI overhead. Therefore, when eight-port transmission in the uplink MIMO system is supported, corresponding precoding matrix selection and indication schemes need to be designed to meet the MIMO uplink enhancement. Through the method for determining a precoding matrix for uplink MIMO transmission disclosed in the embodiments of the present application, a transmission codeword that can be applicable in antenna full coherence of a communication system is determined. The communication system to which the embodiments of the present application are applicable is first described below.

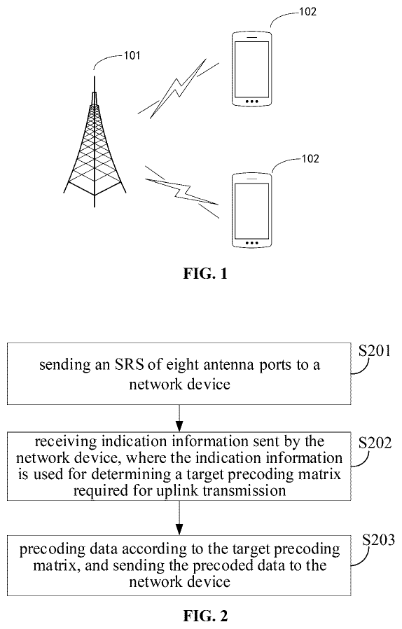

Referring to FIG. 1, FIG. 1 is a schematic diagram of an architecture of a communication system provided by an embodiment of the present disclosure. The communication system may include, but is not limited to, a network device and a terminal device. The number and form of devices shown in FIG. 1 are for example purposes only and do not constitute a limitation to the embodiments of the present disclosure. In practical applications, the communication system may include two or more network devices, and two or more terminal devices. The communication system shown in FIG. 1 includes a network device 101 and a terminal device 102 as an example.

It should be noted that the technical solutions of the embodiments of the present application may be applied to various communication systems, for example, long term evolution (LTE) systems, 5th generation (5G) mobile communication systems, 5G new radio (NR) systems, or other future new mobile communication systems. It should also be noted that the sidelink in the embodiments of the present application may also be referred to as a side link or a direct link.

The network device 101 in the embodiments of the present application is an entity at the network side used for transmitting or receiving signals. For example, the network device 101 may be an evolved NodeB (eNB), a transmission reception point (TRP), a next generation NodeB (gNB) in NR systems, a base station in other future mobile communication systems, or an access node in wireless fidelity (WiFi) systems. The embodiments of the present disclosure do not limit the specific technique and device form adopted by the network device. The network device provided by the embodiments of the present disclosure may be composed of a central unit (CU) and a distributed unit (DU), where the CU may also be referred to as a control unit. The CU-DU structure may be used to separate the protocol layer of the network device such as the base station, with some protocol layer functions placed under centralized control in the CU, and the remaining or all protocol layer functions distributed in the DU, and the DU being centrally controlled by the CU.

The terminal device 102 in the embodiments of the present application is an entity at the user side for receiving or transmitting signals, such as a mobile phone. The terminal device may also be referred to as a terminal, a UE, a mobile station (MS), a mobile terminal (MT) device, etc. The terminal device may be a device with communication capabilities such as a car, a smart car, a mobile phone, a wearable device, or a pad; or the terminal device may be a computer with wireless transceiver capabilities, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, or a wireless terminal device in smart home. The embodiments of the present disclosure do not limit the specific technique and device form used by the terminal device.

In sidelink communication, four sidelink transmission modes are present. Sidelink transmission mode 1 and sidelink transmission mode 2 are used for device-to-device (D2D)) communication of the terminal device. Sidelink transmission mode 3 and sidelink transmission mode 4 are used for vehicle to everything (V2X) communication. When sidelink transmission mode 3 is used, resource allocation is scheduled by the network device 101. Specifically, the network device 101 may send resource allocation information to the terminal device 102, the terminal device 102 then allocates resources to another terminal device, enabling the another terminal device to send information to the network device 101 via the resources as allocated. In V2X communication, a terminal device with a better signal or higher reliability may be used as the terminal device 102. The first terminal device referred to in the embodiments of the present application may refer to the terminal device 102, and the second terminal device may refer to the another terminal device.

It should be understood that the communication system described in the embodiments of the present application is for the purpose of more clearly illustrating the technical solutions of the embodiments of the present application, and does not constitute a limitation on the technical solutions provided in the embodiments of the present application. Those ordinary skilled in the art may know that, with the evolution of the system architecture and the emergence of new service scenarios, the technical solutions provided in the embodiments of the present application are equally applicable to similar technical problems.

It should be noted that the method for determining a precoding matrix for uplink MIMO transmission provided in any one of the embodiments of the present application may be performed independently or in combination with possible implementation manners in other embodiments, and may also be performed in combination with any one of the technical solutions in the related art.

The method and the apparatus for determining a precoding matrix for uplink MIMO transmission provided in the present application are described in detail below in connection with the accompanying drawings.

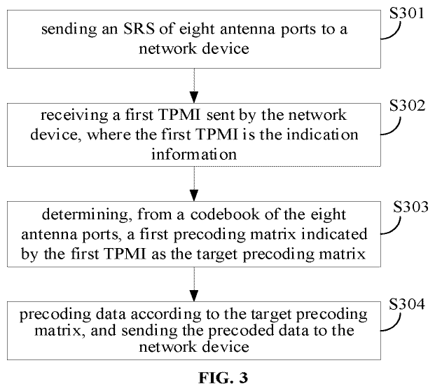

Referring to FIG. 2. FIG. 2 is a flowchart of a method for determining a precoding matrix for uplink MIMO transmission provided by an embodiment of the present application. The method for determining a precoding matrix for uplink MIMO transmission is performed by a terminal device. As shown in FIG. 2, and the method may include, but is not limited to, the following steps S201 to S203.

At S201, an SRS of eight antenna ports is sent to a network device.

In uplink. MIMO codebook-based PUSCH transmission, the terminal device needs to obtain an optimal precoding matrix. In an embodiment of the present application, the terminal device may send the SRSs of eight antenna ports to the network device.

At S202, indication information sent by the network device is received, where the indication information is used for determining a target precoding matrix required for uplink transmission.

After the terminal device sends the SRS to the network device, as a possible implementation, the network device may perform uplink channel estimation based on the SRS sent by the terminal device, and determine from a codebook of the eight antenna ports, based on a result of the channel estimation, an optimal codeword corresponding to the uplink transmission as a first precoding matrix. Further, the network device may determine a transmit precoding matrix indicator (TPMI) corresponding to the first precoding matrix as the indication information, and send the indication information to the terminal device. Accordingly, the terminal device may receive the first TPMI. The terminal device may determine, based on the first TPMI, the target precoding matrix from the codebook of the eight antenna ports, where the first precoding matrix is the target precoding matrix.

As a possible implementation, the network device may perform uplink channel estimation based on the SRS sent by the terminal device, and determine from a codebook of four antenna ports or a codebook of two antenna ports, based on the result of the channel estimation, a four-antenna-port codeword or a two-antenna-port codeword corresponding to an uplink transmission eight-antenna-port optimal codeword as a second precoding matrix. The network device may determine, based on the result of the channel estimation, the first precoding matrix corresponding to the uplink transmission from the codebook of the eight antenna ports. In an embodiment of the present application, the codeword in the codebook of the eight antenna ports are obtained by splicing, based on the codeword coefficient, the lower dimensional codebook of the four antenna ports or the lower dimensional codebook of the two antenna ports. The codeword coefficient associated with the first precoding matrix may be further determined after the first precoding matrix is determined. Further, the network device may determine a second TPMI and a codeword coefficient index of the codeword coefficient as the indication information, and send the indication information to the terminal device. Accordingly, the terminal device may receive the indication information sent by the network device, i.e., receive the second TPMI and the codeword coefficient index. Further, the terminal device may determine the target precoding matrix based on the second TPMI and the codeword coefficient index.

Optionally, the network device may also determine, based on the uplink channel estimation, information such as SRS resources, number of transmission layers, and modulation and coding scheme (MCS) corresponding to the uplink transmission.

The manner of determining the codebook of the four antenna ports and the codebook of the two antenna ports is not limited in the present application, and may be determined according to the actual situation.

Optionally, the codebook of the four antenna ports may be an uplink precoding codebook of the four antenna ports for uplink MIIMO transmission in the 3GPP communication protocol; and the codebook of the two antenna ports may be an uplink precoding codebook of the two antenna ports for uplink MIIMO transmission in the 3GPP communication protocol. Optionally, the codebook of the four antenna ports may be a downlink precoding codebook of the four antenna ports for downlink MIIMO transmission in the 3GPP communication protocol; and the codebook of the two antenna ports may be a downlink precoding codebook of the two antenna ports for downlink MIIMO) transmission in the 3GPP communication protocol.

Optionally, the codebook of the four antenna ports may be determined based on a four-dimensional orthogonal codebook such as a Kerdock codebook; and optionally, the codebook of the two antenna ports may be determined based on a two-dimensional orthogonal codebook such as a Kerdock codebook. It should be noted that the Kerdock codebook is an orthogonal codebook in the communication system design, and may be used for constructing mutually unbiased base sequences. The Kerdock codebook has orthogonality, i.e., any two columns of vectors in each Kerdock codeword are orthogonal to each other.

At S203, data is precoded according to the target precoding matrix, and the precoded data is sent to the network device.

After the target precoding matrix is obtained, the data to be transmitted may be precoded according to the target precoding matrix, and the precoded data may be sent to the network device. The data to be transmitted may be a PUSCH, i.e., the terminal device performs precoding on the PUSCH according to the target precoding matrix and sends the PUSCH as precoded to the network device.

In the embodiments of the present application, the SRS of the eight antenna ports is sent to the network device, the indication information sent by the network device is received, where the indication information is used for determining the target precoding matrix required for the uplink transmission, the data is precoded according to the target precoding matrix, and the precoded data is sent to the network device. In the embodiments of the present application, the target precoding matrix of the eight antenna ports required for the uplink transmission is determined through the uplink channel estimation based on the SRS, which can satisfy the requirement for the uplink MIMO transmission enhancement.

Referring to FIG. 3, FIG. 3 is a flowchart of a method for determining a precoding matrix for uplink MIMO transmission provided by an embodiment of the present application. The method for determining a precoding matrix for uplink MIMO transmission is performed by a terminal device. As shown in FIG. 3, the method may include, but is not limited to, the following steps S301 to S304.

At S301, an SRS of eight antenna ports is sent to a network device.

The specific description of step S301 may be referred to the relevant contents documented in the above embodiments, and is not repeated herein.

At S302, a first TPMI sent by the network device is received, where the first TPMI is the indication information.

At S303, a first precoding matrix indicated by the first TPMI is determined as a target precoding matrix from a codebook of the eight antenna ports.

After the terminal device sends the SRS to the network device, the terminal device may receive the first TPMI sent by the network device. In some implementations, the network device may perform uplink channel estimation based on the SRS sent by the terminal device, and obtain, by traversing the already constructed codebook of the eight antenna ports based on the result of the channel estimation, the codeword (i.e., the optimal codeword corresponding to the uplink transmission) that can maximize the channel capacity, where the optimal codeword corresponding to the uplink transmission is the first precoding matrix. Further, the network device may send the first TPMI corresponding to the first precoding matrix to the terminal device as the indication information.

In the embodiments of the present application, the terminal device may determine, based on the first TPMI, the target precoding matrix from the codebook of the eight antenna ports. In some implementations, each codeword in the codebook of the eight antenna ports is provided with a corresponding TPMI, and a precoding matrix corresponding to the first TPMI may be obtained as the target precoding matrix based on the first TPMI as received and the correspondence between the codeword and the TPMI. It can be understood that the precoding matrix corresponding to the first TPMI is the first precoding matrix determined by the network device side.

Optionally, the codebook of the eight antenna ports may be obtained through splicing based on an existing uplink codebook of the four antenna ports or codebook of the two antenna ports. Optionally, the codebook of the eight antenna ports uses an existing downlink type I codebook or a codebook subset s_{4Tx}.

At S304, data is precoded according to the target precoding matrix, and the precoded data is sent to the network device.

The specific description of step S304 may be referred to the relevant contents documented in the above embodiments, and is not repeated herein.

In the embodiments of the present application, the SRS of the eight antenna ports is sent to the network device, the first TPMI sent by the network device is received, the first TMPI is used for determining the target precoding matrix of the eight antenna ports required for the uplink transmission, the data is precoded according to the target precoding matrix, and the precoded data is sent to the network device. In the embodiments of the present application, the target precoding matrix that can support the uplink MIMO system eight-antenna-port transmission is directly determined through the TPMI, which can satisfy the requirement for the uplink MIMO transmission enhancement.

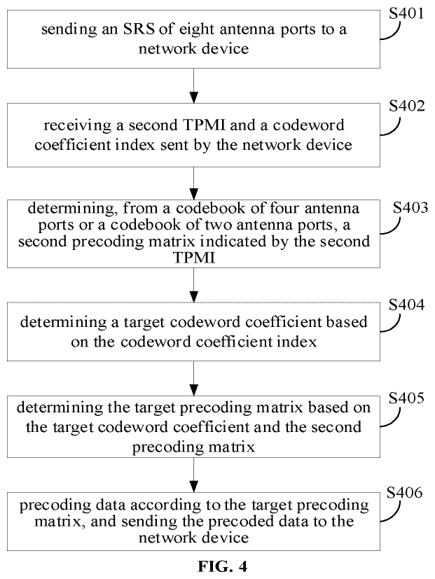

Referring to FIG. 4, FIG. 4 is a flowchart of a method for determining a precoding matrix for uplink MIMO transmission provided by an embodiment of the present application. The method for determining a precoding matrix for uplink. MIMO transmission is performed by a terminal device. As shown in FIG. 4, the method may include, but is not limited to, the following steps S401 to S406.

At S401, an SRS of eight antenna ports is sent to a network device.

The specific description of step S401 may be referred to the relevant contents documented in the above embodiments, and is not repeated herein.

At S402, a second TPMI and a codeword coefficient index sent by the network device are received.

The network device may perform uplink channel estimation based on the SRS sent by the terminal device, and obtain, by traversing the existing codebook of the four antenna ports or codebook of the two antenna ports based on the result of the channel estimation, the codeword (i.e., the optimal codeword corresponding to the uplink transmission) that can maximize the channel capacity, where the optimal codeword corresponding to the uplink transmission is the second precoding matrix. The network device may determine from the codebook of the eight antenna ports, based on the result of the channel estimation, the first precoding matrix corresponding to the uplink transmission. In an embodiment of the present application, the codeword in the codebook of the eight antenna ports for the uplink MIMO transmission is obtained by splicing, in accordance with a splicing formula of the eight-antenna-port codeword, from the lower dimensional codebook of the four antenna ports or the lower dimensional codebook of the two antenna ports by using the codeword coefficient.

After the first precoding matrix is determined, the codeword coefficient associated with the first precoding matrix may be further determined. Further, the network device may determine the second TPMI and the codeword coefficient index of the codeword coefficient as the indication information, and send the indication information to the terminal device. Accordingly, the terminal device may receive the indication information sent by the network device, i.e., receive the second TPMI and the codeword coefficient index.

Optionally, the network device may jointly indicate the second TPMI and the codeword coefficient index to the terminal device, and accordingly, the terminal device may receive the joint indication information, where the joint indication information includes the second TPMI and the codeword coefficient index. The network device may separately indicate the second TPMI and the codeword coefficient index to the terminal device, and accordingly, the terminal device may receive the second TPMI and the codeword coefficient index separately.

At S403, a second precoding matrix indicated by the second TPMI is determined from a codebook of four antenna ports or a codebook of two antenna ports.

Further, each codeword in the codebook of the four antenna ports or the codebook of the two antenna ports is provided with a corresponding TPMI. After obtaining the second TPMI, the terminal device may obtain the precoding matrix corresponding to the second TPMI based on the TPMI correspondence in the codebook of the four antenna ports or the codebook of the two antenna ports, and determines the precoding matrix as determined as the second precoding matrix.

At S404, a target codeword coefficient is determined based on the codeword coefficient index.

Optionally, in the case of a single-antenna panel, the codeword coefficient includes a co-phase coefficient.

Optionally, in the case of a multi-antenna panel, the codeword coefficient includes a co-phase coefficient and a compensation factor of the antenna panel.

It should be noted that under different antenna structures, the corresponding co-phase coefficients are different. For example, when the phase angle interval between antennas is 90°, the co-phase coefficient may be one of: +1, −1, +j, −j, i.e., φ=+1, −1, +j, −j. For another example, when the phase angle interval between antennas is 45°, the co-phase coefficient may be one of:

$$+ 1 , \frac{\sqrt{2}}{2} ( 1 + j ) , + j , \frac{\sqrt{2}}{2} ( - 1 + j ) , - 1 , \frac{\sqrt{2}}{2} ( - 1 - j ) , - j , \frac{\sqrt{2}}{2} ( 1 - j ) .$$

Different phase angle intervals between antennas correspond to different numbers of codeword coefficients included in the candidate codeword coefficient set. In an embodiment of the present application, a correspondence between the codeword coefficient and the codeword coefficient index is pre-constructed. The terminal device may report the codeword coefficient to the network device based on the correspondence. Based on the codeword coefficient index as received, the network device may query the correspondence to determine the codeword coefficient reported by the terminal device.

For example, when the phase angle interval between antennas is 90°, the correspondence between the co-phase coefficient and the coefficient index is shown in Table 1.

TABLE 1

| codeword coefficient index | 0 | 1 | 2 | 3 |
|---|---|---|---|---|
| phase angle interval | 0° | 90° | 180° | 270° |
| co-phase coefficient | +1 | +j | −1 | −j |

As another example, when the phase angle interval between antennas is 45°, the correspondence between the co-phase coefficient and the coefficient index is shown in Table 2.

TABLE 2

| codeword | | | | | | | | |
|---|---|---|---|---|---|---|---|---|
| coefficient index | 0 | 1 | 2 | 3 | 4 | 5 | 6 | 7 |
| phase angle | 0° | 45° | 90° | 135° | 180° | 225° | 270° | 315% |
| interval | | | | | | | | |
| co-phase coefficient | +1 | $\frac{\sqrt{2}}{2} ( 1 + j )$ | +j | $\frac{\sqrt{2}}{2} ( - 1 + j )$ | −1 | $\frac{\sqrt{2}}{2} ( - 1 - j )$ | −j | $\frac{\sqrt{2}}{2} ( 1 - j )$ |

It can be understood that each of the elements in Tables 1 and 2 exists independently, and these elements are exemplarily listed in the same table, but it does not mean that all of the elements in the table must exist at the same time according to what is shown in the table. The value of each of these elements is independent of the value of any other element in Tables 1 and 2. Thus, those skilled in the art can understand that the value of each of the elements in Tables 1 and 2 is an independent embodiment.

In an embodiment of the present application, the network device may determine, based on the phase angle interval between antennas in the antenna structure information, a first number of bits occupied by the codeword coefficient index, and occupy the first number of bits and send the codeword coefficient index to the terminal device. Optionally, the network device may indicate the codeword coefficient index to the terminal device through the bandwidth manner.

As shown in Table 1, in the case where the phase angle interval between antennas is 90°, the candidate codeword coefficient set includes four codeword coefficients, and the network device may determine that the number of first bits occupied by the codeword coefficient index is two, that is to say, the network device needs to occupy two bits to indicate the codeword coefficient index to the terminal device. As shown in Table 2, in the case where the phase angle interval between antennas is 45°, the candidate codeword coefficient set includes eight codeword coefficients, and the network device may determine that the first number of bits occupied by the codeword coefficient index is three, that is to say, the network end device needs to occupy three bits to indicate the codeword coefficient index to the terminal device.

At S405, the target precoding matrix is determined based on the target codeword coefficient and the second precoding matrix.

Further, the terminal device may determine the target precoding matrix by performing codeword splicing based on the second TPMI and the target codeword coefficient. It should be noted that the target precoding matrix is a codeword in the codebook of the eight antenna ports.

It should be noted that the codebook of the eight antenna ports may be obtained by splicing based on the lower dimensional codebook of the four antenna ports and/or the lower dimensional codebook of the two antenna ports. The target codeword coefficient needs to be determined during the splicing process. The second precoding matrix selected from the codebook of the four antenna ports and/or the codebook of the two antenna ports is spliced based on the target codeword coefficient to generate the target precoding matrix. For example, one possible implementation of the target precoding matrix of the eight antenna ports is

$$\text{?} = [ \begin{matrix}\text{?} & \text{?} \\ φ \text{?} & - φ \text{?}\end{matrix} ] \text{?}$$

$$\text{?} \text{indicates text missing or illegible when filed}$$

i.e., the target precoding matrix of the eight antenna ports is obtained by splicing the four-antenna-port codeword and introducing the co-phase coefficient.

At S406, data is precoded according to the target precoding matrix, and the precoded data is sent to the network device.

The specific description of step S406 may be referred to the relevant contents documented in the above embodiments, and will not be repeated herein.

In the embodiments of the present application, based on the existing TPMI mechanism, and in combination with the codeword coefficient, the target precoding matrix that can support the uplink MIMO system eight-antenna-port transmission is determined, which can satisfy the requirement for the uplink MIMO transmission enhancement.

Referring to FIG. 5, FIG. 5 is a flowchart of a method for determining a precoding matrix for uplink MIMO transmission provided by an embodiment of the present application. The method for determining a precoding matrix for uplink MIMO transmission is performed by a terminal device. As shown in FIG. 5, the method may include, but is not limited to, the following steps S501 to S506.

At S501, an SRS of eight antenna ports is sent to a network device.

The specific description of step S501 may be referred to the relevant contents documented in the above embodiments, and is not repeated herein.

At S502, a beam indication and a codeword coefficient index sent by the network device are received.

The network device may determine from the codebook of the eight antenna ports, based on the result of the channel estimation, an optimal codeword corresponding to the uplink transmission as the first precoding matrix. In an embodiment of the present application, the codebook of the eight antenna ports of the uplink MIMO transmission is determined based on the downlink Type I codebook, and each codeword of the eight antenna ports may be obtained by splicing based on the codeword in the downlink Type I codebook, and the codeword coefficient corresponding to the codeword and the beam. After the first precoding matrix is determined based on the result of the channel estimation, the codeword coefficient associated with the first precoding matrix and the target beam associated with the first precoding matrix may be further determined.

Further, the network device may determine a beam indication of the target beam and a codeword coefficient index of the codeword coefficient as the indication information, and send the indication information to the terminal device. Accordingly, the terminal device may receive the indication information sent by the network device. i.e., receive the beam indication and the codeword coefficient index.

Optionally, the first number of bits occupied by the codeword coefficient index is determined based on a phase angle interval between antennas, and the specific process may be referred to the relevant contents documented in the above embodiments, and is not repeated herein.

Optionally, the second number of bits occupied by the beam indication may be determined according to attribute information of the target beam. The attribute information of the target beam may include the values of N1, N2, O1, O2, and the values of i_{1,1}, i_{1,2}, i_{1,3}, i₂ coefficients, etc. supported in the uplink codebook. In some embodiments, N1 and N2 are the number of antenna ports in the first dimension and the number of antenna ports in the second dimension, respectively, and O1, O2 are the value of oversampling in the first dimension and the value of oversampling in the second dimension, respectively. The network device may determine the second number of bits according to the above attribute information, and occupy the second number of bits to send the beam indication to the terminal device.

Optionally, the network device may jointly indicate the beam indication and the codeword coefficient index to the terminal device, and accordingly, the terminal device may receive the joint indication information, where the joint indication information includes the beam indication and the codeword coefficient index. The network device may separately indicate the beam indication and the codeword coefficient index to the terminal device, and accordingly, the terminal device may receive the beam indication and the codeword coefficient index separately.

At S503, a target beam is determined based on the beam indication.

After receiving the beam indication, the terminal device may determine, based on a mapping relationship between the beam indication and the beam, the target beam indicated by the beam indication as received.

At S504, a target codeword coefficient is determined based on the codeword coefficient index.

The specific description of step S504 may be referred to the relevant contents documented in the above embodiments, and is not repeated herein.

At S505, the target precoding matrix is determined based on the target beam and the target codeword coefficient.

After the target beam and the target codeword coefficient are determined, the eight-antenna-port codeword may be determined, according to the formula for generating the eight-antenna-port codeword, as the target precoding matrix. For exemplary illustration, a determination of the codebook of the eight antenna ports based on the downlink Type I codebook is shown in Table 3:

TABLE 3
codebookMode = 1

| i_{1,1} | i_{1,2} | i₂ | |
|---|---|---|---|
| 0, J, K, N₁O₁−1 | 0, K, N₂O₂−1 | 0,1 | $\text{?}$ |

$where \text{?} = \frac{1}{\sqrt{2 {P}_{CSI - RS}}} [ \begin{matrix}\text{?} & \text{?} \\ \text{?} & \text{?}\end{matrix} ] .$
and the mapping from i_{1,3} to k₁ and k₂ is given in Table 5.2.2.2.1-3.
$\text{?} \text{indicates text missing or illegible when filed}$

where v denotes the selected target beam, which is a broadband characteristic; and φₙ denotes the co-phase coefficient, which is a narrowband characteristic.

At S506, data is precoded according to the target precoding matrix, and the precoded data is sent to the network device.

The specific description of step S506 may be referred to the relevant contents documented in the above embodiments, and will not be repeated herein.

In the embodiments of the present application, the network device indicates the codeword coefficient and the target beam to the terminal device, and the terminal device may determine, based on the codeword coefficient and the target beam, the target precoding matrix that can support the uplink MIMO system eight-antenna-port transmission, which can satisfy the requirement for the uplink MIMO transmission enhancement.

It should be noted that the target codeword coefficient may include a co-phase coefficient and a compensation factor between antennas. In some embodiments, the co-phase coefficient and the compensation factor may be determined by using the same manner, or the co-phase coefficient and the compensation factor may be determined by using different manners. In some implementations, both the co-phase coefficient and the compensation factor are determined based on the SRS. In yet some implementations, one of the co-phase coefficient and the compensation factor is determined based on the SRS, and another one of the co-phase coefficient and the compensation factor is determined based on another manner. For example, the co-phase coefficient may be determined based on the SRS manner described above, and the compensation factor may be determined based on another manner. For further example, the compensation factor may be determined based on the SRS manner described above, and the co-phase coefficient may be determined based on another manner.

In some implementations, the terminal device may receive a channel state information-reference signal (CSI-RS) of the eight antenna ports sent by the network device. Further, after receiving the CSI-RS, the terminal device may perform downlink channel estimation based on the CSI-RS, and based on a result of the downlink channel estimation, determine a second term in the target codeword coefficient adapted to the current channel state, for example, the compensation factor or the co-phase coefficient may be determined based on the CSI-RS.

In other implementations, the terminal device may determine the second term in the target codeword coefficient based on the antenna structure information. For example, the terminal device may determine the second term in the target codeword coefficient based on the phase angle interval between antennas indicated by the antenna structure information. The compensation factor or the co-phase coefficient may be determined, for example, based on the phase angle interval between antennas. Different phase angle intervals between antennas may correspond to different co-phase coefficients, as shown in Table 1 or 2.

It can be understood that the co-phase coefficient and the compensation factor may be determined by using the same manner, or the co-phase coefficient and the compensation factor may be determined by using different manners, which is applicable to embodiments of the present application.

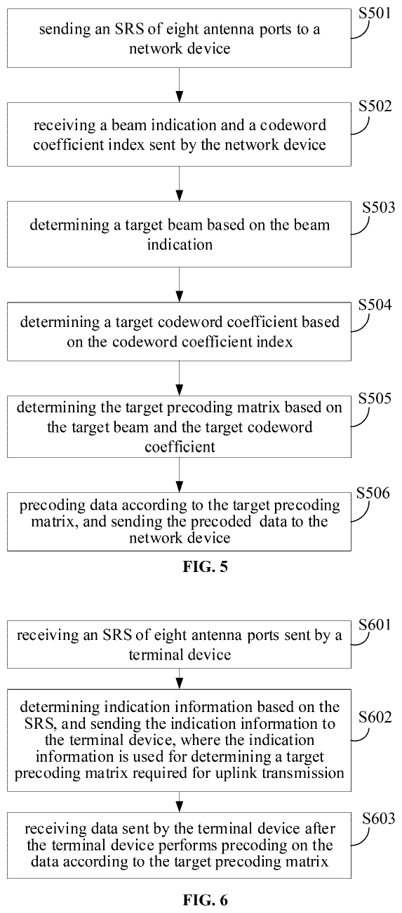

Referring to FIG. 6. FIG. 6 is a flowchart of a method for determining a precoding matrix for uplink MIMO transmission provided by an embodiment of the present application. The method for determining a precoding matrix for uplink MIMO transmission is performed by a network device. As shown in FIG. 6, and the method may include, but is not limited to, the following steps S601 to S603.

At S601, an SRS of eight antenna ports sent by a terminal device is received.

In uplink MIMO codebook-based PUSCH transmission, the terminal device needs to obtain an optimal precoding matrix. In an embodiment of the present application, the terminal device may send, based on the codebook, the SRSs of eight antenna ports to the network device. Accordingly, the network device may receive the SRSs of eight antenna ports sent by the terminal device.

At S602, indication information is determined based on the SRS, and the indication information is sent to the terminal device, where the indication information is used for determining a target precoding matrix required for uplink transmission.

After the terminal device sends the SRS to the network device, as a possible implementation, the network device may perform uplink channel estimation based on the SRS sent by the terminal device, and determine from a codebook of the eight antenna ports, based on a result of the channel estimation, an optimal codeword corresponding to the uplink transmission as a first precoding matrix. Further, the network device may determine a TPMI corresponding to the first precoding matrix as the indication information, and send the indication information to the terminal device. Accordingly, the terminal device may receive the first TPMI. The terminal device may determine, based on the first TPMI, the target precoding matrix from the codebook of the eight antenna ports, where the first precoding matrix is the target precoding matrix.

As a possible implementation, the network device may perform uplink channel estimation based on the SRS sent by the terminal device, and determine from a codebook of four antenna ports or a codebook of two antenna ports, based on the result of the channel estimation, a four-antenna-port codeword or a two-antenna-port codeword corresponding to an uplink transmission eight-antenna-port optimal codeword as a second precoding matrix. The network device may determine, based on the result of the channel estimation, the first precoding matrix corresponding to the uplink transmission from the codebook of the eight antenna ports. In an embodiment of the present application, the codeword in the codebook of the eight antenna ports are obtained by splicing, based on the codeword coefficient, the lower dimensional codebook of the four antenna ports or the lower dimensional codebook of the two antenna ports. The codeword coefficient associated with the first precoding matrix may be further determined after the first precoding matrix is determined. Further, the network device may determine a second TPMI and a codeword coefficient index of the codeword coefficient as the indication information, and send the indication information to the terminal device. Accordingly, the terminal device may receive the indication information sent by the network device, i.e., receive the second TPMI and the codeword coefficient index. Further, the terminal device may determine the target precoding matrix based on the second TPMI and the codeword coefficient index.

Optionally, the network device may also determine, based on the uplink channel estimation, information such as SRS resources, number of transmission layers, and MCS corresponding to the uplink transmission.

At 603, data sent by the terminal device after the terminal device performs precoding on the data according to the target precoding matrix is received.

After the first precoding matrix is obtained, the terminal device may perform, based on the first precoding matrix, precoding on the data to be transmitted, and send the precoded data to the network device. Accordingly, the network device may receive the precoded data. Optionally, the data to be transmitted may be a PUSCH, i.e., the terminal device performs precoding on the PUSCH based on the first precoding matrix, and the network device may receive the PUSCH as precoded.

In the embodiments of the present application, the SRS of the eight antenna ports sent by the terminal device is received, the indication information is determined based on the SRS, and the indication information is sent to the terminal device, where the indication information is used for determining the target precoding matrix required for the uplink transmission, and the data sent by the terminal device after the terminal device performs precoding on the data according to the target precoding matrix is received. In the embodiments of the present application, the target precoding matrix of the eight antenna ports required for the uplink transmission is determined through the uplink channel estimation based on the SRS, which can satisfy the requirement for the uplink MIMO transmission enhancement.

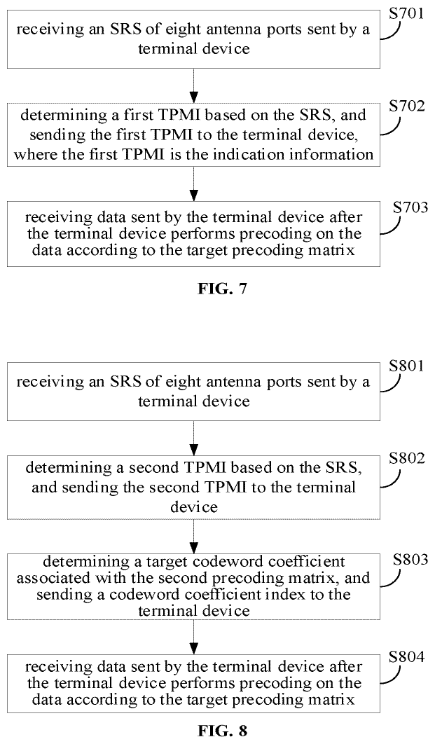

Referring to FIG. 7, FIG. 7 is a flowchart of a method for determining a precoding matrix for uplink MIMO transmission provided by an embodiment of the present application. The method for determining a precoding matrix for uplink MIMO transmission is performed by a network device. As shown in FIG. 7, the method may include, but is not limited to, the following steps S701 to S703.

At S701, an SRS of eight antenna ports sent by a terminal device is received.

The specific description of step S701 may be referred to the relevant contents documented in the above embodiments, and is not repeated herein.

At S702, a first TPMI is determined based on the SRS, and the first TPMI is sent to the terminal device, where the first TPMI is the indication information.

In some embodiments, the first TPMI is used for indicating the terminal device to determine, from a codebook of the eight antenna ports, a first precoding matrix indicated by the first TPMI, and the first precoding matrix is the target precoding matrix.

After the terminal device sends the SRS to the network device, the network device may perform uplink channel estimation based on the SRS sent by the terminal device, and obtain, by traversing the already constructed codebook of the eight antenna ports based on the result of the channel estimation, the codeword (i.e., the optimal codeword corresponding to the uplink transmission) that can maximize the channel capacity, where the optimal codeword corresponding to the uplink transmission is the first precoding matrix. Further, the network device may send the first TPMI corresponding to the first precoding matrix to the terminal device as the indication information.

Further, the terminal device may determine, based on the first TPMI, the target precoding matrix from the codebook of the eight antenna ports. In some implementations, each codeword in the codebook of the eight antenna ports is provided with a corresponding TPMI, and a precoding matrix corresponding to the first TPMI may be obtained as the target precoding matrix based on the first TPMI as received and the correspondence between the codeword and the TPMI.

Optionally, the codebook of the eight antenna ports may be obtained through splicing based on an existing uplink codebook of the four antenna ports or codebook of the two antenna ports. Optionally, the codebook of the eight antenna ports uses an existing downlink type I codebook or a codebook subset s_{4Tx}.

At 703, data sent by the terminal device after the terminal device performs precoding on the data according to the target precoding matrix is received.

The specific description of step S703 may be referred to the relevant contents documented in the above embodiments, and is not repeated herein.

In the embodiments of the present application, the SRS of the eight antenna ports sent by the terminal device is received, and the first TPMI is determined based on the SRS and is sent to the terminal device, where the first TPMI is the indication information, and the data sent by the terminal device after the terminal device performs precoding on the data according to the target precoding matrix is received. In the embodiments of the present application, the target precoding matrix that can support the uplink MIMO system eight-antenna-port transmission is directly determined through the TPMI, which can satisfy the requirement for the uplink MIMO transmission enhancement.

Referring to FIG. 8, FIG. 8 is a flowchart of a method for determining a precoding matrix for uplink MIMO transmission provided by an embodiment of the present application. The method for determining a precoding matrix for uplink MIMO transmission is performed by a network device. As shown in FIG. 8, the method may include, but is not limited to, the following steps S801 to S804.

At S801, an SRS of eight antenna ports sent by a terminal device is received.

The specific description of step S801 may be referred to the relevant contents documented in the above embodiments, and is not repeated herein.

At S802, a second TPMI is determined based on the SRS, and the second TPMI is sent to the terminal device.

In some embodiments, the second TPMI is used for indicating the terminal device to determine, from a codebook of four antenna ports or a codebook of two antenna ports, a second precoding matrix indicated by the second TPMI.

The network device may perform uplink channel estimation based on the SRS sent by the terminal device, and obtain the codeword (i.e., the optimal codeword corresponding to the uplink transmission) that can maximize the channel capacity of the estimated optimal channel by traversing, based on the result of the channel estimation, the existing codebook of the four antenna ports or codebook of the two antenna ports, where the optimal codeword corresponding to the uplink transmission is the second precoding matrix. The network device may determine from the codebook of the eight antenna ports, based on the result of the channel estimation, the first precoding matrix corresponding to the uplink transmission. In an embodiment of the present application, the codeword in the codebook of the eight antenna ports for the uplink MIMO transmission is obtained by splicing, in accordance with a splicing formula of the eight-antenna-port codeword, from the lower dimensional codebook of the four antenna ports or the lower dimensional codebook of the two antenna ports by using the codeword coefficient.

At 803, a target codeword coefficient associated with the second precoding matrix is determined, and a codeword coefficient index is sent to the terminal device.

In some embodiments, the codeword coefficient index is used for determining the target codeword coefficient. The second precoding matrix and the target codeword coefficient are used for determining the target precoding matrix.

After the first precoding matrix is determined, the codeword coefficient associated with the first precoding matrix may be further determined. Further, the network device may determine the second TPMI and the codeword coefficient index of the codeword coefficient as the indication information, and send the indication information to the terminal device. Optionally, the network device may jointly indicate the second TPMI and the codeword coefficient index to the terminal device; or the network device may separately indicate the second TPMI and the codeword coefficient index to the terminal device.

In an embodiment of the present application, the network device may determine, based on the phase angle interval between antennas in the antenna structure information, a first number of bits occupied by the codeword coefficient index, and occupy the first number of bits and send the codeword coefficient index to the terminal device. Optionally, the network device may indicate the codeword coefficient index to the terminal device through the bandwidth manner.

Further, the terminal device determines the second precoding matrix based on the second TPMI, and the specific process may be referred to the relevant contents documented in the above embodiments, and is not be repeated herein.

Further, the terminal device determines the target codeword coefficient based on the codeword coefficient index, and the specific process may be referred to the relevant contents documented in the above embodiments, and is not be repeated herein.

At 804, data sent by the terminal device after the terminal device performs precoding on the data according to the target precoding matrix is received.

The specific description of step S804 may be referred to the relevant contents documented in the above embodiments, and is not repeated herein.

In the embodiments of the present application, based on the existing TPMI mechanism, and in combination with the codeword coefficient, the target precoding matrix that can support the uplink MIMO system eight-antenna-port transmission is determined, which can satisfy the requirement for the uplink MIMO transmission enhancement.

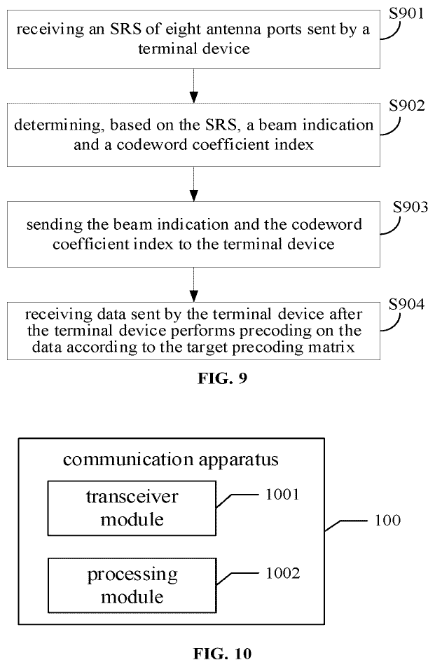

Referring to FIG. 9, FIG. 9 is a flowchart of a method for determining a precoding matrix for uplink MIMO transmission provided by an embodiment of the present application. The method for determining a precoding matrix for uplink MIMO transmission is performed by a network device. As shown in FIG. 9, the method may include, but is not limited to, the following steps S901 to S904.

At S901, an SRS of eight antenna ports sent by a terminal device is received.

The specific description of step S901 may be referred to the relevant contents documented in the above embodiments, and is not repeated herein.

At S902, a beam indication and a codeword coefficient index are determined based on the SRS.

At S903, the beam indication and the codeword coefficient index are sent to the terminal device.

In some embodiments, the beam indication is used for determining a target beam, the codeword coefficient index is used for determining a target codeword coefficient, and the target beam and the target codeword coefficient are used for determining the target precoding matrix.

The network device may determine from the codebook of the eight antenna ports, based on the result of the channel estimation, an optimal codeword corresponding to the uplink transmission as the first precoding matrix. In an embodiment of the present application, the codebook of the eight antenna ports of the uplink MIMO transmission is determined based on the downlink Type I codebook, and each codeword of the eight antenna ports may be obtained by splicing based on the codeword in the downlink Type I codebook, and the codeword coefficient corresponding to the codeword and the beam. After the first precoding matrix is determined based on the result of the channel estimation, the codeword coefficient associated with the first precoding matrix and the target beam associated with the first precoding matrix may be further determined. Further, the network device may determine a beam indication of the target beam and a codeword coefficient index of the codeword coefficient as the indication information, and send the indication information to the terminal device.

Optionally, the first number of bits occupied by the codeword coefficient index is determined based on a phase angle interval between antennas, and the specific process may be referred to the relevant contents documented in the above embodiments, and is not repeated herein.

Optionally, the network device may determine, according to attribute information of the target beam, a second number of bits, and occupy the second number of bits to send the beam indication to the terminal device. The specific process may be referred to the relevant contents documented in the above embodiments, and is not repeated herein.

The second number of bits occupied by the beam indication may be determined according to the attribute information of the target beam, and the specific process may be referred to the relevant contents documented in the above embodiments, and is not repeated herein.

Optionally, the network device may jointly indicate the beam indication and the codeword coefficient index to the terminal device; or the network device may separately indicate the beam indication and the codeword coefficient index to the terminal device.

Further, after receiving the codeword coefficient index, the terminal device may determine the target codeword coefficient based on the codeword coefficient index, and the specific process may be referred to the relevant contents documented in the above embodiments, and is not repeated herein.

Further, after receiving the beam indication, the terminal device may determine the target beam based on the beam indication, and the specific process may be referred to the relevant contents documented in the above embodiments, and is not repeated herein.

At 904, data sent by the terminal device after the terminal device performs precoding on the data according to the target precoding matrix is received.

The specific description of step S904 may be referred to the relevant contents documented in the above embodiments, and is not repeated herein.

In the embodiments of the present application, the network device indicates the codeword coefficient and the target beam to the terminal device, and the terminal device may determine, based on the codeword coefficient and the target beam, the target precoding matrix that can support the uplink MIMO system eight-antenna-port transmission, which can satisfy the requirement for the uplink MIMO transmission enhancement.

It should be noted that the target codeword coefficient may include a co-phase coefficient and a compensation factor between antennas. In some embodiments, the co-phase coefficient and the compensation factor may be determined by using the same manner, or the co-phase coefficient and the compensation factor may be determined by using different manners. In some implementations, both the co-phase coefficient and the compensation factor are determined based on the SRS. In yet some implementations, one of the co-phase coefficient and the compensation factor is determined based on the SRS, and another one of the co-phase coefficient and the compensation factor is determined based on another manner. For example, the co-phase coefficient may be determined based on the SRS manner described above, and the compensation factor may be determined based on another manner. For further example, the compensation factor may be determined based on the SRS manner described above, and the co-phase coefficient may be determined based on another manner.

In some implementations, the terminal device may receive a CSI-RS of the eight antenna ports sent by the network device. Further, after receiving the CSI-RS, the terminal device may perform downlink channel estimation based on the CSI-RS, and based on a result of the downlink channel estimation, determine a second term in the target codeword coefficient adapted to the current channel state, for example, the compensation factor or the co-phase coefficient may be determined based on the CSI-RS.

In other implementations, the terminal device may determine the second term in the target codeword coefficient based on the antenna structure information. For example, the terminal device may determine the second term in the target codeword coefficient based on the phase angle interval between antennas indicated by the antenna structure information. The compensation factor or the co-phase coefficient may be determined, for example, based on the phase angle interval between antennas. Different phase angle intervals between antennas may correspond to different co-phase coefficients, as shown in Table 1 or 2.

In the above embodiments provided by the present application, the methods provided by the embodiments of the present application are introduced from the perspectives of the network device and the terminal device respectively. In order to achieve the functions of the methods provided by the embodiments of the present application, the network device and the terminal device may include hardware structures and software modules, and achieve the functions described above by means of hardware structures, software modules or hardware structure plus software modules. A certain one of the above functions may be executed in the form of hardware structure, software module, or hardware structure plus software module.

Referring to FIG. 10, FIG. 10 is a schematic diagram of a structure of a communication apparatus 100 provided by an embodiment of the present application. The communication apparatus 100 shown in FIG. 10 may include a transceiver module 1001 and a processing module 1002. The transceiver module 1001 may include a sending module and/or a receiving module. The sending module is configured to implement a sending function, and the receiving module is configured to implement a receiving function. The transceiver module 1001 may implement the sending function and/or the receiving function.

The communication apparatus 100 may be a terminal device, an apparatus in a terminal device, or an apparatus capable of being used in conjunction with a terminal device. Alternatively, the communication apparatus 100 may be a network device, an apparatus in a network device, or an apparatus capable of being used in conjunction with a network device.

The communication apparatus 100 is a terminal device, and the transceiver module 1001 is configured to: send an SRS of eight antenna ports to a network device; receive indication information sent by the network device, where the indication information is used for determining a target precoding matrix required for uplink transmission; and perform precoding on data according to the target precoding matrix, and send the precoded data to the network device.

Optionally, the transceiver module 1001 is further configured to receive a first TPMI sent by the network device, where the first TPMI is the indication information.

Optionally, the processing module 1002 is further configured to determine, from a codebook of the eight antenna ports, a first precoding matrix indicated by the first TPMI as the target precoding matrix.

Optionally, the transceiver module 1001 is further configured to receive a second TPMI and a codeword coefficient index sent by the network device.

Optionally, the processing module 1002 is further configured to: determine, from a codebook of four antenna ports or a codebook of two antenna ports, a second precoding matrix indicated by the second TPMI; determine a target codeword coefficient based on the codeword coefficient index; and obtain the target precoding matrix based on the target codeword coefficient and the second precoding matrix.

Optionally, the transceiver module 1001 is further configured to receive a beam indication and a codeword coefficient index sent by the network device.

Optionally, the processing module 1002 is further configured to determine a target beam based on the beam indication, determine a target codeword coefficient based on the codeword coefficient index, and determine the target precoding matrix based on the target beam and the target codeword coefficient.

Optionally, a first number of bits occupied by the codeword coefficient index is determined based on a phase angle interval between antennas.

Optionally, a second number of bits occupied by the beam indication is determined according to attribute information of the target beam.

Optionally, the target codeword coefficient includes a co-phase coefficient and/or a compensation factor of an antenna panel.

Optionally, both the co-phase coefficient and the compensation factor are determined based on the SRS; or

optionally, one of the co-phase coefficient and the compensation factor is determined based on the SRS, and another one of the co-phase coefficient and the compensation factor is determined based on another manner.

The communication apparatus 100 is a network device, and the transceiver module 1001 is configured to: receive an SRS of eight antenna ports sent by a terminal device; determine indication information based on the SRS, and send the indication information to the terminal device, where the indication information is used for determining a target precoding matrix required for uplink transmission; and receive data sent by the terminal device after the terminal device performs precoding on the data according to the target precoding matrix.

Optionally, the transceiver module 1001 is further configured to: determine a first TPMI based on the SRS, and send the first TPMI to the terminal device, where the first TPMI is the indication information, the first TPMI is used for indicating the terminal device to determine, from a codebook of the eight antenna ports, a first precoding matrix indicated by the first TPMI, and the first precoding matrix is the target precoding matrix.

Optionally, the transceiver module 1001 is further configured to: determine a second TPMI based on the SRS, and send the second TPMI to the terminal device, where the second TPMI is used for indicating the terminal device to determine, from a codebook of four antenna ports or a codebook of two antenna ports, a second precoding matrix indicated by the second TPMI; and determine a target codeword coefficient associated with the second precoding matrix, and send a codeword coefficient index to the terminal device, where the codeword coefficient index is used for determining the target codeword coefficient; where the second precoding matrix and the target codeword coefficient are used for determining the target precoding matrix.

Optionally, the processing module 1002 is further configured to determine, based on the SRS, a beam indication and a codeword coefficient index.

Optionally, the transceiver module 1001 is further configured to send the beam indication and the codeword coefficient index to the terminal device; where the beam indication is used for determining a target beam, the codeword coefficient index is used for determining a target codeword coefficient, and the target beam and the target codeword coefficient are used for determining the target precoding matrix.

Optionally, the processing module 1002 is further configured to: determine, based on antenna structure information, a first number of bits occupied by the codeword coefficient index; and occupy the first number of bits, and send the codeword coefficient index to the terminal device.

Optionally, the processing module 1002 is further configured to determine the first number of bits based on a phase angle interval between antennas indicated by the antenna structure information.

Optionally, the processing module 1002 is further configured to: determine, according to attribute information of the target beam, a second number of bits occupied by the beam indication; and occupy the second number of bits, and send the beam indication to the terminal device.

Optionally, the target codeword coefficient includes a co-phase coefficient and/or a compensation factor of an antenna panel, and the processing module 1002 is further configured to determine the co-phase coefficient and the compensation factor based on a same manner or different manners.

Optionally, the processing module 1002 is further configured to: determine, based on the SRS, the co-phase coefficient and the compensation factor; or determine, based on the SRS, a first one of the co-phase coefficient and the compensation factor, and determine, based on another manner, a remaining second one of the co-phase coefficient and the compensation factor.

In the embodiments of the present application, the SRS of the eight antenna ports is sent to the network device, the indication information sent by the network device is received, where the indication information is used for determining the target precoding matrix required for the uplink transmission, the data is precoded according to the target precoding matrix, and the precoded data is sent to the network device. In the embodiments of the present application, the target precoding matrix of the eight antenna ports required for the uplink transmission is determined through the uplink channel estimation based on the SRS, which can satisfy the requirement for the uplink MIMO transmission enhancement.

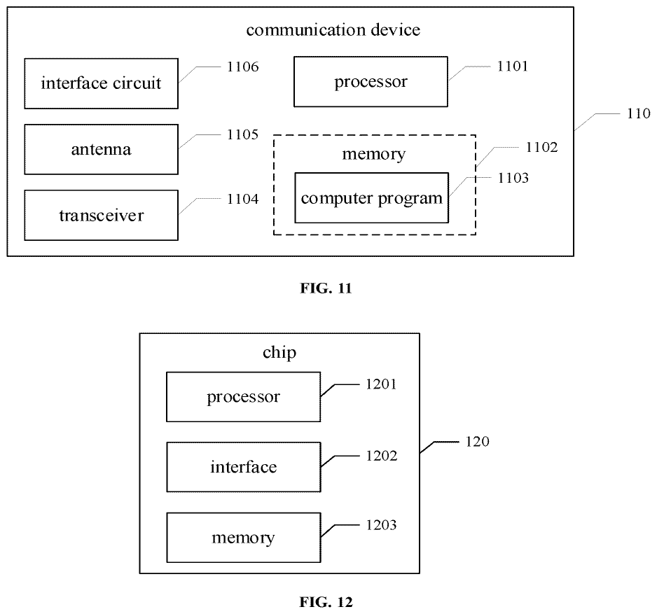

Referring to FIG. 11, FIG. 11 is a schematic diagram of a structure of another communication device 110 provided by an embodiment of the present application. The communication device 110 may be a network device, a terminal device, or a chip, a chip system or a processor, etc. that supports a network device in implementing the methods described above; or the communication device 110 may be a chip, a chip system or a processor, etc. that supports a terminal device in implementing the methods described above. The device may be configured to implement the methods described in the aforementioned method embodiments. For details, please refer to the illustration in the above method embodiments.

The communication device 110 may include one or more processors 1101. The processor 1101 may be a general purpose processor or specialized processor, etc. For example, the processor 1101 may be a baseband processor or central processor. The baseband processor may be configured to process communication protocols and communication data. The central processor may be configured to control the communication device (e.g., a base station, a baseband chip, a terminal device, a terminal device chip, a DU, or a CU), execute a computer program, and process data of the computer program.

Optionally, the communication device 110 may further include one or more memories 1102. The one or more memories 1102 may store a computer program 1103. The processor 1101 executes the computer program 1103 to cause the communication device 110 to perform the methods described in the above method embodiments. Optionally, the memory 1102 may also store data. The communication device 110 and the memory 1102 may be provided separately or may be integrated together.

Optionally, the communication device 110 may further include a transceiver 1104 and an antenna 1105. The transceiver 1104 may be referred to as a transceiver unit, a transceiver device, or a transceiver circuit, etc., and is configured to implement the receiving and sending functions. The transceiver 1104 may include a receiver and a sender. The receiver may be referred to as a receiving device or a receiving circuit, etc., and is configured to implement a receiving function. The sender may be referred to as a sending device or a sending circuit, etc., and is configured to implement a sending function.

Optionally, the communication device 110 may further include one or more interface circuits 1106. The interface circuit 1106 is configured to receive a code instruction and transmit the code instruction to the processor 1101. The processor 1101 runs the code instruction to cause the communication device 110 to perform the methods described in the above method embodiments.

The communication device 110 is a terminal device for implementing the functions of the terminal device in the aforementioned embodiments.

The communication device 110 is a network device for implementing the functions of the network device in the aforementioned embodiments.

In an implementation, the processor 1101 may include a transceiver configured to implement the receiving and sending functions. For example, the transceiver may be a transceiver circuit, an interface, or an interface circuit. The transceiver circuit, interface, or interface circuit configured to implement the receiving and sending functions may be separate or may be integrated together. The transceiver circuit, interface, or interface circuit described above may be configured for code/data reading and writing, or the transceiver circuit, interface, or interface circuit described above may be configured for signal transmission or delivery.

In an implementation, the processor 1101 may store a computer program 1103. The computer program 1103 is run on the processor 1101 and may cause the communication device 110 to perform the methods described in the above method embodiments. The computer program 1103 may be solidified in the processor 1101, in which case the processor 1101 may be implemented by hardware.

In an implementation, the communication device 110 may include a circuit. The circuit may implement the functions of sending, receiving or communicating in the aforementioned method embodiments. The processor and transceiver described in the present application may be implemented in an integrated circuit (IC), an analog IC, a radio frequency integrated circuit (RFIC), a mixed signal IC, an application specific integrated circuit (ASIC), a printed circuit board (PCB), and an electronic device, etc. The processor and transceiver may also be manufactured by using various IC process technologies, such as complementary metal oxide semiconductor (CMOS), negative channel metal oxide semiconductor (NMOS), positive channel metal oxide semiconductor (PMOS), bipolar junction transistor (BIT), bipolar CMOS (BiCMOS), silicon germanium (SiGe), gallium arsenide (GaAs), etc.

The communication device in the description of the above embodiments may be a network device or a terminal device, but the scope of the communication device described in the present application is not limited thereto. The structure of the communication device may not be limited by FIG. 11. The communication device may be an independent device or may be a part of a large apparatus. For example, the described communication device may be:
(1) an independent integrated circuit (IC), a chip, or a chip system or subsystem;
(2) a set that has one or more ICs, optionally, the IC set may also include a storage component configured to store data and computer programs;
(3) an ASIC, such as a modem;
(4) a module that is capable of being embedded in other devices;
(5) a receiving device, a terminal device, an intelligent terminal device, a cellular phone, a wireless device, a handheld device, a mobile unit, a vehicle-mounted device, a network device, a cloud device, or an artificial intelligence device, etc.;
(6) others and so on.

For the case where the communication device may be a chip or a chip system, please refer to the schematic diagram of the structure of the chip shown in FIG. 12. The chip shown in FIG. 12 includes a processor 1201 and an interface 1202. In some embodiments, the number of processors 1201 may be one or more, and the number of interfaces 1202 may be more than one.

The chip 120 is a terminal device for implementing the functions of the terminal device in the aforementioned embodiments.

The interface 1202 is configured to: send an SRS of eight antenna ports to a network device; receive indication information sent by the network device, where the indication information includes and is used for determining a target precoding matrix required for uplink transmission; and perform precoding on data according to the target precoding matrix, and send the precoded data to the network device.

Optionally, the interface 1202 is further configured to receive a first TPMI sent by the network device, where the first TPMI is the indication information.

Optionally, the processor 1201 is further configured to determine, from a codebook of the eight antenna ports, a first precoding matrix indicated by the first TPMI as the target precoding matrix.

Optionally, the interface 1202 is further configured to receive a second TPMI and a codeword coefficient index sent by the network device.

Optionally, the processor 1201 is further configured to: determine, from a codebook of four antenna ports or a codebook of two antenna ports, a second precoding matrix indicated by the second TPMI; determine a target codeword coefficient based on the codeword coefficient index; and obtain the target precoding matrix based on the target codeword coefficient and the second precoding matrix.

Optionally, the interface 1202 is further configured to receive a beam indication and a codeword coefficient index sent by the network device.

Optionally, the processor 1201 is further configured to determine a target beam based on the beam indication, determine a target codeword coefficient based on the codeword coefficient index, and determine the target precoding matrix based on the target beam and the target codeword coefficient.

Optionally, a first number of bits occupied by the codeword coefficient index is determined based on a phase angle interval between antennas.

Optionally, a second number of bits occupied by the beam indication is determined according to attribute information of the target beam.

Optionally, the target codeword coefficient includes a co-phase coefficient and/or a compensation factor of an antenna panel.

Optionally, both the co-phase coefficient and the compensation factor are determined based on the SRS: or
optionally, one of the co-phase coefficient and the compensation factor is determined based on the SRS, and another one of the co-phase coefficient and the compensation factor is determined based on another manner.

The chip 120 is a network device for implementing the functions of the network device in the aforementioned embodiments.

The interface 1202 is configured to: receive an SRS of eight antenna ports sent by a terminal device; determine indication information based on the SRS, and send the indication information to the terminal device, where the indication information is used for determining a target precoding matrix required for uplink transmission; and receive data sent by the terminal device after the terminal device performs precoding on the data according to the target precoding matrix.

Optionally, the interface 1202 is further configured to: determine a first TPMI based on the SRS, and send the first TPMI to the terminal device, where the first TPMI is the indication information, the first TPMI is used for indicating the terminal device to determine, from a codebook of the eight antenna ports, a first precoding matrix indicated by the first TPMI, and the first precoding matrix is the target precoding matrix.

Optionally, the interface 1202 is further configured to: determine a second TPMI based on the SRS, and send the second TPMI to the terminal device, where the second TPMI is used for indicating the terminal device to determine, from a codebook of four antenna ports or a codebook of two antenna ports, a second precoding matrix indicated by the second TPMI; and determine a target codeword coefficient associated with the second precoding matrix, and send a codeword coefficient index to the terminal device, where the codeword coefficient index is used for determining the target codeword coefficient; where the second precoding matrix and the target codeword coefficient are used for determining the target precoding matrix.

Optionally, the processor 1201 is further configured to determine, based on the SRS, a beam indication and a codeword coefficient index.

Optionally, the interface 1202 is further configured to send the beam indication and the codeword coefficient index to the terminal device: where the beam indication is used for determining a target beam, the codeword coefficient index is used for determining a target codeword coefficient, and the target beam and the target codeword coefficient are used for determining the target precoding matrix.

Optionally, the processor 1201 is further configured to: determine, based on antenna structure information, a first number of bits occupied by the codeword coefficient index; and occupy the first number of bits, and send the codeword coefficient index to the terminal device.

Optionally, the processor 1201 is further configured to determine the first number of bits based on a phase angle interval between antennas indicated by the antenna structure information.

Optionally, the processor 1201 is further configured to: determine, according to attribute information of the target beam, a second number of bits occupied by the beam indication; and occupy the second number of bits, and send the beam indication to the terminal device.

Optionally, the target codeword coefficient includes a co-phase coefficient and/or a compensation factor of an antenna panel, and the processor 1201 is further configured to determine the co-phase coefficient and the compensation factor based on a same manner of different manners.

Optionally, the processor 1201 is further configured to: determine, based on the SRS, the co-phase coefficient and the compensation factor; or determine, based on the SRS, a first one of the co-phase coefficient and the compensation factor, and determine, based on another manner, a remaining second one of the co-phase coefficient and the compensation factor.

The chip 120 further includes a memory 1203, where the memory 1203 is configured to store necessary computer programs and data.

In the embodiments of the present application, the SRS of the eight antenna ports is sent to the network device, the indication information sent by the network device is received, where the indication information is used for determining the target precoding matrix required for the uplink transmission, the data is precoded according to the target precoding matrix, and the precoded data is sent to the network device. In the embodiments of the present application, the target precoding matrix of the eight antenna ports required for the uplink transmission is determined through the uplink channel estimation based on the SRS, which can satisfy the requirement for the uplink MIMO transmission enhancement.

Those skilled in the art can also understand that various illustrative logical blocks and steps listed in the embodiments of the present application may be implemented through electronic hardware, computer software, or a combination of the two. Whether such functions are implemented through hardware or software depends on the specific application and design requirements of the overall system. Those skilled in the art can use various methods to implement the described functions for each specific application, but such implementations should not be understood as exceeding the scope of protection of the embodiments of the present application.

The embodiments of the present application also provide a communication system including a communication device used as a terminal device and a communication device used as a network device in the aforementioned embodiment of FIG. 10, or the system includes a communication device used as a terminal device and a communication device used as a network device in the aforementioned embodiment of FIG. 11.

The present application also provides a readable storage medium. The readable storage medium stores an instruction. The instruction, when executed by a computer, implements the function of any of the method embodiments described above.

The present application also provides a computer program product. The computer program product, when executed by a computer, implements the function of any of the method embodiments described above.

The above embodiments may be implemented in whole or in part by software, hardware, firmware, or any combination thereof. When implemented by using software, the above embodiments may be implemented in whole or in part in the form of a computer program product. The computer program product includes one or more computer programs. When the computer program is loaded and executed on a computer, a process or function is produced in whole or in part in accordance with the embodiments of the present application. The computer may be a general purpose computer, a specialized computer, a computer network, or other programmable devices. The computer program may be stored in a computer-readable storage medium or transmitted from one computer-readable storage medium to another computer-readable storage medium, e.g., the computer program may be transmitted from a web site, computer, server, or data center via a wired (e.g., coaxial cable, fiber optic, digital subscriber line (DSL)) or wireless (e.g., infrared, wireless, microwave, etc.) manner to another web site, computer, server, or data center. The computer-readable storage medium may be any usable medium to which a computer has access, or a data storage device such as a server or a data center including one or more usable media integration. The usable medium may be a magnetic medium (e.g., a floppy disk, a hard disk, a tape), an optical medium (e.g., a high-density digital video disc (DVD)), or a semiconductor medium (e.g., a solid state disk (SSD)), etc.

Those ordinary skilled in the art can understand that various numerical numbers such as “first” and “second” involved in the present application are only differentiation for the convenience of the description, and are not used for limiting the scope of the embodiments of the present application or indicate the sequential order.

The “at least one” in the present application may also be described as one or more, and the “plurality” may be two, three, four, or more, without limitation in the present application. In the embodiments of the present application, for one type of technical feature, technical features of this type are distinguished by “first”, “second”, “third”, “A”, “B”, “C”, and “D”, etc. The technical features described by “first”, “second”, “third”, “A”, “B”, “C”, and “D”, etc. are in no order of sequence or size.

The correspondence relationships shown in the tables of the present application may be configured or may be pre-defined. The values of the information in the tables are merely examples and may be configured to other values, which are not limited by the present application. In configuring the correspondence relationship between the information and the parameters, it is not necessarily required that all the correspondence relationships illustrated in the tables must be configured. For example, the correspondence relationships illustrated in certain rows of the tables in the present application may also not be configured. For another example, it is possible to make appropriate deformations and adjustments based on the above tables, such as splitting and merging. The names of the parameters shown in the headings in the above-described tables may also be other names understandable by the communication device, and the values or representations of the parameters thereof may also be other values or representations understandable by the communication device. The above tables may also be realized by using other data structures, such as arrays, queues, containers, stacks, linear tables, pointers, chain lists, trees, graphs, structure bodies, classes, heaps, hashing tables, or hash tables.

The “pre-define” in the present application may be understood as “define”, “define in advance”, “store”, “pre-store”, “pre-negotiate”, “pre-configure”, “solidified”, or “pre-fired”.

Those ordinary skilled in the art can realize that the units and algorithm steps of the examples described in combination with the disclosed embodiments in this article may be implemented in electronic hardware, or a combination of computer software and electronic hardware. Whether these functions are executed in hardware or software manners depends on the specific application and design constraints of the technical solution. Professional technicians may use different methods to implement the described functions for each specific application, but such implementations should not be considered beyond the scope of the present application.

Those skilled in the art can clearly understand that for the convenience and conciseness of the description, the specific working processes of the systems, devices and units described above may refer to the corresponding processes in the aforementioned method embodiments, which will not be repeated herein.

The above is only the detailed description of the present application, but the scope of protection of the present application is not limited to this. Any technician familiar with this technical field can easily think of changes or replacements within the technical scope disclosed in the present application, and these changes or replacements should be covered within the scope of protection of the present application. Therefore, the scope of protection of the present application shall be subject to the scope of protection of the claims.

1. A method for determining a precoding matrix for uplink multiple input multiple output (MIMO) transmission, performed by a terminal device, comprising:
sending a sounding reference signal (SRS) of eight antenna ports to a network device;
receiving indication information sent by the network device, wherein the indication information is used for indicating a target precoding matrix required for uplink transmission; and
precoding data according to the target precoding matrix, and sending the precoded data to the network device.

2. The method according to claim 1, further comprising:
receiving a first transmit precoding matrix indicator (TPMI) sent by the network device, wherein the first TPMI is the indication information; and
determining, from a codebook of the eight antenna ports, a first precoding matrix indicated by the first TPMI as the target precoding matrix.

3. The method according to claim 1, further comprising:
receiving a second TPMI and a codeword coefficient index sent by the network device;
determining, from a codebook of four antenna ports or a codebook of two antenna ports, a second precoding matrix indicated by the second TPMI;
determining a target codeword coefficient based on the codeword coefficient index; and
determining the target precoding matrix based on the target codeword coefficient and the second precoding matrix.

4. The method according to claim 1, further comprising:
receiving a beam indication and a codeword coefficient index sent by the network device;
determining a target beam based on the beam indication;
determining a target codeword coefficient based on the codeword coefficient index; and
determining the target precoding matrix based on the target beam and the target codeword coefficient.

5. The method according to claim 3, wherein a first number of bits occupied by the codeword coefficient index is determined based on a phase angle interval between antennas.

6. The method according to claim 4, wherein a second number of bits occupied by the beam indication is determined according to attribute information of the target beam.

7. The method according to claim 3, wherein the target codeword coefficient comprises at least one of a co-phase coefficient or a compensation factor of an antenna panel, and
the co-phase coefficient and the compensation factor are determined based on the SRS; or one of the co-phase coefficient and the compensation factor is determined based on the SRS, and another one of the co-phase coefficient and the compensation factor is determined based on another manner.

8. A method for determining a precoding matrix for uplink multiple input multiple output (MIMO) transmission, performed by a network device, comprising:
receiving a sounding reference signal (SRS) of eight antenna ports sent by a terminal device;
determining indication information based on the SRS, and sending the indication information to the terminal device, wherein the indication information is used for indicating a target precoding matrix required for uplink transmission; and
receiving data sent by the terminal device after the terminal device performs precoding on the data according to the target precoding matrix.

9. The method according to claim 8, further comprising:
determining a first transmit precoding matrix indicator (TPMI) based on the SRS, and sending the first TPMI to the terminal device, wherein the first TPMI is the indication information, the first TPMI is used for indicating the terminal device to determine, from a codebook of the eight antenna ports, a first precoding matrix indicated by the first TPMI, and the first precoding matrix is the target precoding matrix.

10. The method according to claim 8, further comprising:
determining a second TPMI based on the SRS, and sending the second TPMI to the terminal device, wherein the second TPMI is used for indicating the terminal device to determine, from a codebook of four antenna ports or a codebook of two antenna ports, a second precoding matrix indicated by the second TPMI; and
determining a target codeword coefficient associated with the second precoding matrix, and sending a codeword coefficient index to the terminal device, wherein the codeword coefficient index is used for determining the target codeword coefficient; wherein
the second precoding matrix and the target codeword coefficient are used for determining the target precoding matrix.

11. The method according to claim 8, further comprising:
determining, based on the SRS, a beam indication and a codeword coefficient index; and
sending the beam indication and the codeword coefficient index to the terminal device; wherein
the beam indication is used for determining a target beam, the codeword coefficient index is used for determining a target codeword coefficient, and the target beam and the target codeword coefficient are used for determining the target precoding matrix.

12. The method according to claim 10, further comprising:
determining, based on antenna structure information, a first number of bits occupied by the codeword coefficient index; and
occupying the first number of bits, and sending the codeword coefficient index to the terminal device.

13. The method according to claim 12, further comprising:
determining the first number of bits based on a phase angle interval between antennas indicated by the antenna structure information.

14. The method according to claim 11, further comprising:
determining, according to attribute information of the target beam, a second number of bits occupied by the beam indication; and
occupying the second number of bits, and sending the beam indication to the terminal device.

15. The method according to claim 10, wherein the target codeword coefficient comprises at least one of a co-phase coefficient or a compensation factor of an antenna panel, and the method further comprises:
determining, in response to the target codeword coefficient comprising the co-phase coefficient and the compensation factor of the antenna panel, the co-phase coefficient and the compensation factor based on a same manner or different manners.

16. The method according to claim 15, further comprising:
determining, based on the SRS, the co-phase coefficient and the compensation factor; or
determining, based on the SRS, a first one of the co-phase coefficient and the compensation factor, and determining, based on another manner, a second one of the co-phase coefficient and the compensation factor.

17-18. (canceled)

19. A communication device, comprising:
a memory, storing a computer program; and
a processor, wherein
the processor, through executing the computer program stored in the memory, is configured to:
send a sounding reference signal (SRS) of eight antenna ports to a network device,
receive indication information sent by the network device, wherein the indication information is used for indicating a target precoding matrix required for uplink transmission, and
perform precoding on data according to the target precoding matrix, and send the precoded data to the network device;
or
receive an SRS of eight antenna ports sent by a terminal device,
determine indication information based on the SRS, and send the indication information to the terminal device, wherein the indication information is used for indicating a target precoding matrix required for uplink transmission, and
receive data sent by the terminal device after the terminal device performs precoding on the data according to the target precoding matrix.

20. (canceled)

21. A communication device, comprising a processor and an interface circuit; wherein
the interface circuit is configured to receive a code instruction and transmit the code instruction to the processor; and
the processor is configured to run the code instruction, thereby performing the method according to claim 1.

22. A communication device, comprising a processor and an interface circuit; wherein
the interface circuit is configured to receive a code instruction and transmit the code instruction to the processor; and
the processor is configured to run the code instruction, thereby performing the method according to claim 8.

23. A non-transitory computer-readable storage medium, configured to store an instruction, wherein the instruction, when executed by an electronic device, causes the electronic device to perform the method according to claim 1.

24. (canceled)
